(19) United States
(12) Patent Application Publication
(10) Pub. No.: US 2024/0160499 A1
(43) Pub. Date: May 16, 2024

(54) Augmenting Handling of Logs Generated in PaaS Environments

(71) Applicant: Google LLC, Mountain View, CA (US)

(72) Inventors: Tissa Rohitha Senevirathne, Sunnyvale, CA (US); Bo Eric Wang, Seattle, WA (US); Carlos Lugtu, Mountain View, CA (US); Bharadwaj Venkateswara Sridhar Subramanian, San Jose, CA (US); Madhukar Narayan Thakur, San Jose, CA (US)

(73) Assignee: Google LLC, Mountain View, CA (US)

(21) Appl. No.: 18/055,185

(22) Filed: Nov. 14, 2022

(51) Int. Cl. G06F 9/54; G06F 21/62

(52) U.S. Cl. CPC G06F 9/54; G06F 21/6218

(57) ABSTRACT

A method for augmenting handling of logs generated in platform as a system (PaaS) environments includes transmitting, to an external cloud computing environment, an application programming interface (API) request. The API request includes a trace identification (ID), a concealment indicator, and a policy ID. The method also includes updating the first entry in the first log corresponding to the API request based on the trace ID and the concealment indicator. The method also includes storing the first entry in the first log corresponding to the API request based on the storage criteria of the policy ID.

### TECHNICAL FIELD

This disclosure relates to methods for augmenting handling of logs generated in platform as a service (PaaS) environments.

### BACKGROUND

Platform as a service (PaaS) generally refers to a cloud-hosted computing environment that allows customers to easily provision and manage computing platforms and applications. In particular, PaaS provides users access to hardware and software that the users can access and manage without having to maintain any of the PaaS infrastructure locally. The PaaS environment can include tools, applications, operating systems, servers, storage, firewalls, etc. Recently, PaaS has evolved such that customers can build complex tools that span across multiple PaaS environments.

### SUMMARY

One aspect of the disclosure provides for a computer-implemented method for augmenting handling of logs generated in platform as a service (PaaS) environments, when executed by data processing hardware, causes the data processing hardware to perform operations including transmitting, to an external cloud computing environment, an application programming interface (API) request including a trace identification (ID) including a unique reference object for a first entry in a first log corresponding to the API request, a concealment indicator including a Boolean parameter indicating that data corresponding to the API request is confidential, and a policy identification (ID) indicating a storage criteria for the first entry in the first log corresponding to the API request. The operations further include updating the first entry in the first log corresponding to the API request based on the trace ID and the concealment indicator. The operations include storing the first entry in the first log corresponding to the API request based on the storage criteria of the policy ID.

Implementations of the disclosure may include one or more of the following optional features. In some implementations, the API request is configured to cause the external cloud computing environment to update a second entry in a second log corresponding to the API request, the second entry in the second log comprising the trace ID. In these implementations, a first logic of the Boolean parameter of the concealment indicator may cause the cloud computing device to remove one or more sensitive data fields of data of the API request from the second entry of the second log. Further, in these implementations, the operations may further include receiving, from the external cloud computing environment, the second log, retrieving, from the second log, the trace ID from the second entry corresponding to the API request, and retrieving, from a database, using the trace ID, the one or more sensitive data fields removed from the second entry of the second log.

In some implementations, storing the first entry in the first log includes storing the first entry in the first log for a threshold length of time based on the storage criteria of the policy ID. In other implementations, the operations further include receiving, from the external cloud computing environment, a response to the API request. In these implementations, the operations include updating a third entry in the first log corresponding to the API request based on the response, the trace ID, and the concealment indicator. The first log may include an event log or the trace ID. Further, the trace ID may include a hash key. In some implementations, the trace ID is included within a body of the API request.

Another aspect of the disclosure provides a system for augmenting handling of logs generated in platform as a service (PaaS) environments. The system includes data processing hardware and memory hardware in communication with the data processing hardware. The memory hardware stores instructions that when executed on the data processing hardware cause the data processing hardware to perform operations. The operations include transmitting, to an external cloud computing environment, an application programming interface (API) request including a trace identification (ID) including a unique reference object for a first entry in a first log corresponding to the API request, a concealment indicator including a Boolean parameter indicating that data corresponding to the API request is confidential, and a policy identification (ID) indicating a storage criteria for the first entry in the first log corresponding to the API request. The operations further include updating the first entry in the first log corresponding to the API request based on the trace ID and the concealment indicator. The operations include storing the first entry in the first log corresponding to the API request based on the storage criteria of the policy ID.

This aspect may include one or more of the following optional features. In some implementations, the API request is configured to cause the external cloud computing environment to update a second entry in a second log corresponding to the API request, the second entry in the second log comprising the trace ID. In these implementations, a first logic of the Boolean parameter of the concealment indicator may cause the cloud computing device to remove one or more sensitive data fields of data of the API request from the second entry of the second log. Further, in these implementations, the operations may further include receiving, from the external cloud computing environment, the second log, retrieving, from the second log, the trace ID from the second entry corresponding to the API request, and retrieving, from a database, using the trace ID, the one or more sensitive data fields removed from the second entry of the second log.

In some implementations, storing the first entry in the first log includes storing the first entry in the first log for a threshold length of time based on the storage criteria of the policy ID. In other implementations, the operations further include receiving, from the external cloud computing environment, a response to the API request. In these implementations, the operations include updating a third entry in the first log corresponding to the API request based on the response, the trace ID, and the concealment indicator. The first log may include an event log or the trace ID. Further, the trace ID may include a hash key. In some implementations, the trace ID is included within a body of the API request.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for augmenting handling of logs generated in platform as a service (PaaS) environments.

FIG. 2 is a schematic view of an example log manager updating respective entries in a first log and a second log.

FIG. 3 is a schematic view of an example log manager correlating respective entries from a first log and a second log.

FIG. 4 a flowchart of an example arrangement of operations for a method of augmenting handling of logs generated in PaaS environments.

FIG. 5 is a schematic view of an example computing device that may be used to implement the systems and methods described herein.

Like reference symbols in the various drawings indicate like elements.

### DETAILED DESCRIPTION

Platform as a Service (PaaS) is a type of cloud computing service that provides cloud-hosted software and hardware that allows users to build software solutions, such as computer programs and applications. Recently, PaaS has emerged as an important instrument in building scalable cloud computing solutions. For example, a user can build complex solutions using multiple PaaS environments hosted by different providers. The multiple PaaS environments may communicate with each other during operation and independently log records of such communications. However, correlating logs from different PaaS environments can be difficult as each PaaS environment is responsible for maintain its own log and even timestamps between the services often vary enough to make correlation or synchronization difficult if not impossible.

Further, due to various compliance and regulatory requirements, cloud platform users require PaaS to handle logs and traces in a compliant manner. Current implementations do not provide sufficient granularity to differentiate between data types for the logs (e.g., synthetic/test data versus real and potentially confidential data) and thus all data is logged in a similar manner. For example, current implementations obfuscate or drop all information in fields that have a potential for sensitivity. As a result, troubleshooting becomes challenging as this data is lost and cannot be reconstructed. Additionally, logs of different PaaS environments are frequently stored for a fixed duration according to regulatory requirements. However, certain data (e.g., test data) does not need to be stored as long as other data (e.g., real data) governed by regulatory requirements, and thus storing test data for the fixed duration places an undue burden on storage resources.

The current disclosure is aimed at augmenting handling of logs generated in PaaS environments to provide granularity in the handling of logs and the ability to correlate/synchronize logs from disparate PaaS environments. In particular, implementations herein introduce a number of parameters to be included in application programming interface (API) calls used to communicate between PaaS environments. The parameters included in the API calls can be used direct the management of logs and/or correlate logs between different PaaS environments.

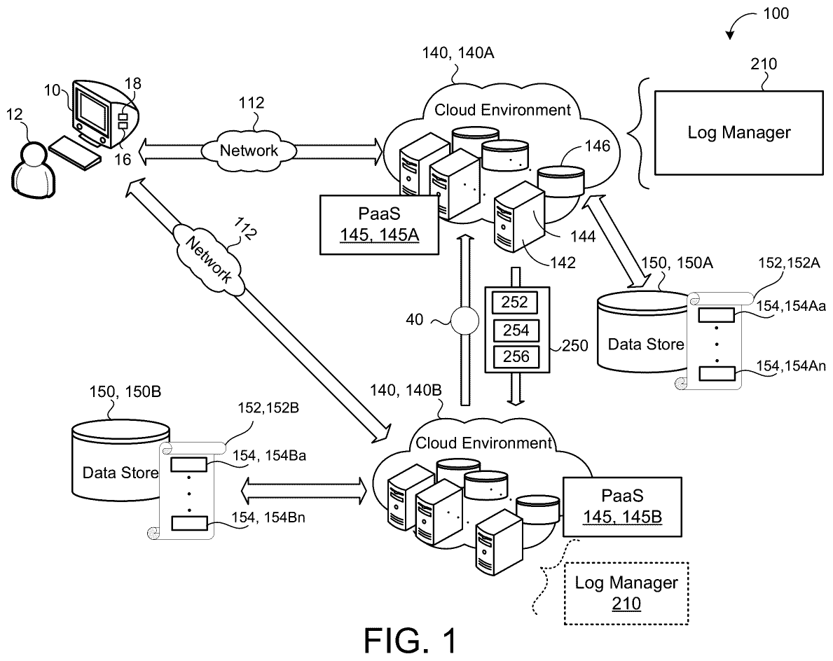

FIG. 1 is a schematic view of an example system 100 for augmenting handling of logs generated in PaaS environments. The system 100 includes a client 12 using a client device 10 to access multiple cloud computing environments 140, 140A-B. The client device 10 includes data processing hardware 16 and memory hardware 18. The client device 10 can be any computing device capable of communicating with the cloud computing environments 140 through, for example, one or more networks 112. The client device 10 includes, but is not limited to, desktop computing devices and mobile computing devices, such as laptops, tablets, smart phones, smart speakers/displays, smart appliances, internet-of-things (IoT) devices, and wearable computing devices (e.g., headsets and/or watches).

In some implementations, the client device 10 is in communication with a first cloud computing environment 140A and a second cloud computing environment 140B via the network 112. Each first cloud computing environment 140 may be a single computer, multiple computers, or a distributed system (e.g., a cloud environment) having scalable/elastic resources 142 including computing resources 144 (e.g., data processing hardware) and/or storage resources 146 (e.g., memory hardware). The cloud computing environments 140 may each host a PaaS environment 145, 145A-B that provides corresponding hardware and software applications for use by the client device 10. A data store 150, 150A-B may be used to store a log 152, 152A-B corresponding to messages and actions of the respective PaaS environment 145. In some implementations, the data store 150 of one or more of the cloud computing environments 140 is available to a log manager 210, such that the log manager 210 can manage and/or update the log 152 and one or more corresponding entries 154, 154Aa-Bn of the log 152. Each entry 154 in the log 152 may relate to an event (e.g., a message via an API or an action) in the PaaS environment 145 and may include data related to the event such as a timestamp, type of event, content of the event, etc. In some implementations, the entry 154 includes one or more additional parameters 252, 254, 256 to enable correlation of logs 152 between the disparate PaaS environments 145. Some or all of the parameters 252, 254, 256 may be received from the client 10.

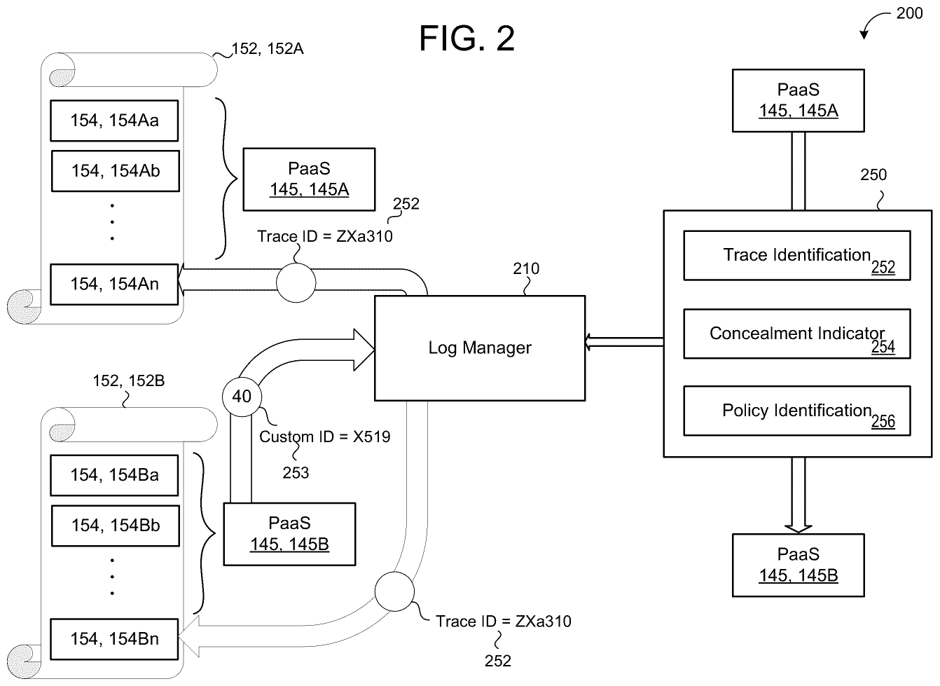

In some implementations, the first cloud computing environment 140A is communicatively coupled to the external second cloud computing environment 140B. In some implementation, each cloud computing environment 140 executes a log manager 210. In other implementations, only one of the cloud computing environments 140 executes a log manager 210. Regardless, each respective log manager 210 may manage or update the entries 154 in the respective log 152. For example, the PaaS environment 145A transmits an application programming interface (API) request 250 to the PaaS environment 145B. The API request 250 includes one or more of a trace identification 252, a concealment indicator 254, and a policy identification 256. In response to the API request 250, the PaaS environment 145B transmits a response 40 back to the PaaS environment 145A. In response to the API request 250 and/or response 40, the log manager 210 updates the respective log 152 with respective entries 154 based on the parameters 252, 254, 256, as discussed in greater detail with reference to FIG. 2.

Although not illustrated, the system 100 may include any number of additional cloud computing environments 140, each hosting a respective PaaS environment 145. Additionally, each PaaS environment 145 may be communicatively coupled to any appropriate number of data stores 150, and each data store may include one or more logs 152. For example, a data store 150 includes a log 152 that records events in the PaaS environment 145 to provide an audit trail (i.e., an event log) as well as a log 152 that records events in the PaaS environment 145 for troubleshooting purposes (i.e., a troubleshooting log or transactions log). Alternatively, each data store 150 is configured with a single log 152 for a particular purpose (i.e., one data store 150 corresponding to an event log 152 and one data store 150 corresponding to a transaction log 152). Further, the log manager 210 may be hosted in a single cloud computing environment 140. In some implementations, the log manager 210 is hosted jointly over multiple cloud computing environments 140.

FIG. 2 is an exemplary schematic view 200 of the log manager 210 updating respective entries 154 in the first log 152A of the first PaaS environment 145A and the second log 152B of the second PaaS environment 145B. The log manager 210 in this example may be a single log manager 210 partially executing within each PaaS environment 145A-B or two separate and independent log managers 210. Here, the log manager 210 receives an API request 250 sent from the first PaaS environment 145A to the second PaaS environment 145B. In turn, the log manager 210 updates the entries 154A-B in respective logs 152A-B. The API request 250 includes a number of parameters such as a trace identification (ID) 252, a concealment indicator 254, and/or a policy ID 256 that each may impact how the log manager 210 updates the logs 152A-B. In some implementations, the API request 250 includes the parameters (i.e., the trace ID 252, the concealment indicator 254, and/or policy ID 256) in a body of the API request 250. In other implementations, the API request 250 includes the parameters 252, 254, 256 in a header and/or path perimeter of the API request 250. Alternatively, the API request 250 includes some combination of parameters 252, 254, 256 in the body of the API request 250 and the remaining parameter(s) 252, 254, 256 in the path perimeter of the API request 250. The parameters 252, 254, and/or 256 may be received from a from a client device 10. Alternatively, the parameters 252, 254, and/or 256 are generated at the first PaaS environment 145A, the second PaaS environment 145B, or some combination thereof.

The trace ID 252 may be a unique identifier that is included in each entry 154 corresponding to the API request 250. In some examples, the trace ID 252 is unique to all other entries 154 of the log 152. In other examples, the trace ID 252 is unique to specific types of entries 154, but multiple entries 154 are correlated together based on the same trace ID 252. The trace ID 252, in some examples, includes a unique reference object, such as a hash key or unique reference number. In some implementations, the trace ID 252 is unique for each API request 250 such that the respective entries 154 corresponding to each API request 250 are correlated by the trace ID 252. In other implementations, one or more API requests 250 that are similar or related can share the trace ID 252. Further, in some implementations, the trace ID 252 only has meaning to the caller (i.e., the PaaS environment 145 generating the API request 250) and includes additional metadata or a JavaScript Object Notation (JSON) object. In these implementations, although the trace ID 252 has no meaning to the receiver (i.e., the PaaS environment 145 receiving the API request 250), the log manager 210 still includes the trace ID 252 when updating entries 154 in the respective log 152 for the respective receiving PaaS environment 145. In other words, the log manager 210 includes the trace ID 252 in each respective entry 154 corresponding to the API request 250. Accordingly, the trace ID 252 may be used to correlate logs between disparate PaaS environments 145, as discussed in more detail below.

The concealment indicator 254, in some examples, includes a Boolean parameter indicating that at least some data of the API request 250 is confidential/sensitive. For example, when the concealment indicator 254 is set to “true,” the log manager 210 removes or anonymizes or otherwise sanitizes one or more sensitive data fields from data corresponding to the API request 250 before logging the data in the respective entry 154 of the respective log 152 correspond to the API request 250. In some implementations, the log manager 210 only removes the one or more sensitive fields from the entry 154 in the log 152 of the receiving PaaS environment 145. In other implementations, the log manger 210 removes the one or more sensitive fields from all entries 154 corresponding to the API request 250. In some of these implementations, the caller side PaaS environment 145 stores the sensitive data in a database along with the corresponding trace ID 252 such that the log manager 210 can reconstruct removed sensitive data for an entry 154 using the trace ID 252. The concealment indicator 254 may be set to “true” for all API requests 250 related to events that must be maintained for regulatory compliance. For example, when the first PaaS environment 145A sends an API request 250 to the second PaaS environment 145B that includes confidential information, the first PaaS environment 145A includes the concealment indicator 254 (along with the trace ID 252) with the API request 250 indicating the presence of the confidential data. In this example, the first PaaS environment 145A has access to the confidential information (e.g., in a secure database) and the second PaaS environment 145B, upon receipt of the API request 250, does not log the confidential information. However, upon reconstruction/synchronization of the logs 152, the first PaaS environment 145A can correlate the confidential data stored (e.g., stored in the secure database) with the API request 250 based on the trace ID 252.

The policy ID 256, in some implementations, indicates storage criteria for one or more entries 154 corresponding to the respective API request 250. For example, the policy ID 256 indicates a length of storage or other retention policy (e.g., store for one month, store for one year, etc.), a particular or type of database for storage, security measures to implement (e.g., encryption), etc. The log manager 210 may store the policy ID 256 as part of the corresponding entries 154. In some implementations, the log manager 210 periodically scans the logs 152 to update one or more entries 154 based on updates to a storage criteria related to a respective policy ID 256. For example, a particular policy ID 256 has a storage criteria indicating that corresponding entries 154 are to be stored for 30 days. When a user updates the particular policy ID 256 to lengthen of shorten the period of time based on needs of the user, the log manager 210 updates each entry 154 corresponding to the updated particular policy ID 256.

As an illustrative example with reference to the schematic view 200 of FIG. 2, the first PaaS environment 145A transmits the API request 250 to the second PaaS environment 145B. In response to the API request 250, the second PaaS environment 145B generates a response 40. Based at least on the API request 250, the log manager 210 adds/updates an entry 154An of the log 152A and a corresponding entry 154Bn of the log 152B. The log manager 210 may also update the entries 154An, 154Bn based on the response 40 and/or add additional entries 154. In some implementations, the response 40 includes a custom identification (ID) 253 generated by the second PaaS environment 145B. The custom ID 253 may be a simple transaction identification number or a unique reference object that only has meaning to the receiver (i.e., the PaaS environment 145 generating the response 40). Like the trace ID 252, the log manager 210 stores the custom ID 253 in each entry 154 corresponding to the API request 250 and/or response 40.

In some implementations, the log manager 210 analyzes the policy ID 256 to determine how and/or where to update/add respective entries 154. For example, the policy ID 256 includes a storage criteria indicating that the log manager 210 is to update the log 152B in a particular database. In another example, the policy ID 256 includes a storage criteria indicating that the log manager 210 is to update the log 152B, where the log 152B is a particular type of log (e.g., an event log 152 or a transaction log 152). Additionally or alternatively, the log manager 210 analyzes the concealment indicator 254 to determine whether or not to remove one or more sensitive data fields of the API request 250 when updating the corresponding entries 154. In some implementations, the log manager 210 only removes the sensitive data fields when updating the log 152B corresponding to the receiving PaaS environment 145 (i.e., the second PaaS environment 145B in this example). In some implementations, the log manager 210 stores the one or more sensitive data fields in a storage related to the caller PaaS environment 145 along with the trace ID 252. The log manager 210 updates the respective entries 154 with the trace ID 252, the policy ID 256, and/or the appropriate data from the API request 250.

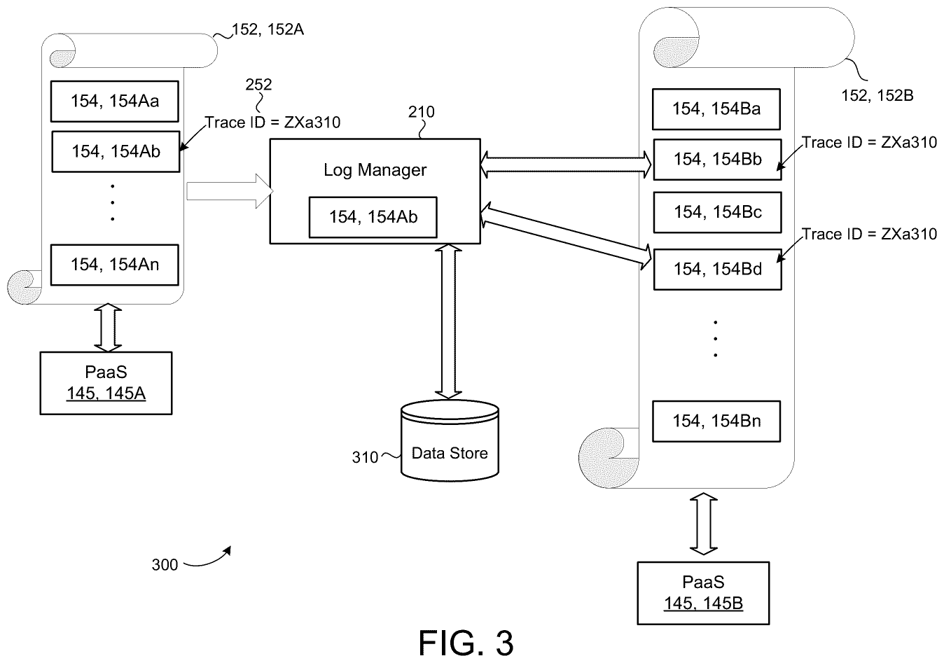

FIG. 3 is a schematic view 300 of the log manager 210 correlating respective entries 154 from the first log 152A and the second log 152B. In some implementations, the log manager 210 receives the log 152A corresponding to the first PaaS environment 145A. The log manager 210 may receive the log 152 from a caller PaaS environment 145 or a receiver PaaS environment 145. The log manager 210 retrieves a respective trace ID 252 from a respective entry 154 of the log 152A. In some implementations, the log manager 210 receives the respective entry 154 (e.g., entry 154Ab) and accordingly retrieves the trace ID 252 from the respective entry 154. In other implementation, the log manager 210 receives the trace ID 252 as in input (e.g., from a user or another PaaS environment 145). In these implementations, the log manager 210 searches one or more logs 152 corresponding to one or more PaaS environments 145 belonging to disparate cloud computing environments 140 for the entry 154 corresponding to the received trace ID 252. In the example of FIG. 3, the log manager 210 identifies entries 154Bb and 154Bd of log 152B that share the trace ID 252 with the entry 154Ab of the log 152A. In some implementations, the entries 154Bb, 154Bd include one or more sensitive data fields that are not included in the corresponding entry 154Ab. For example, the log manager 210 updates/creates the entries 154Bb, 154Bd in response to an API request 250 with a concealment indicator 254 set to “true” and accordingly removes one or more sensitive data fields from the entries 154Bb, 154Bd. In other implementations, the log manager 210 searches a database 310 using the trace ID 252. The database 310 can include sensitive data tagged or otherwise associated with respective trace IDs 252. Accordingly, the log manager 210 can reconstruct the entry 154Ab using the trace ID 252 to retrieve the sensitive data from a database 310 or one or more entries 154 that match the trace ID 252 (e.g., entries 154Bb and 154Bd).

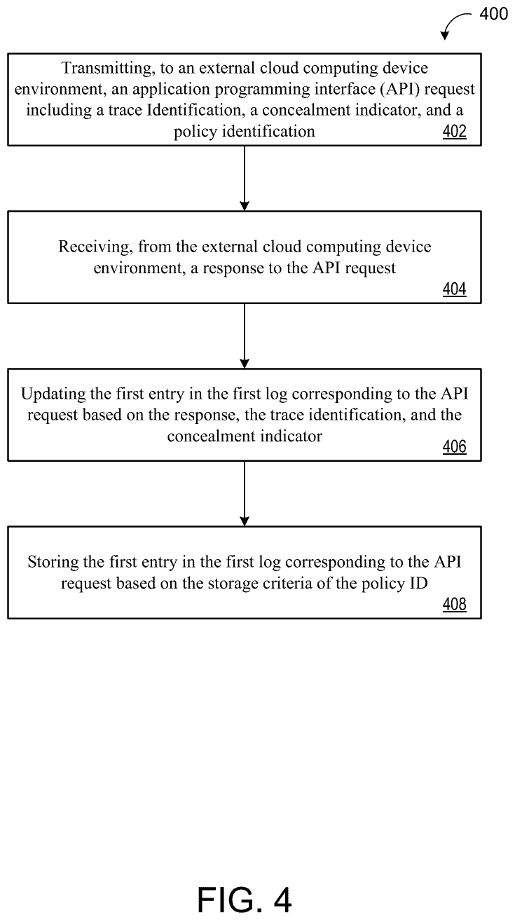

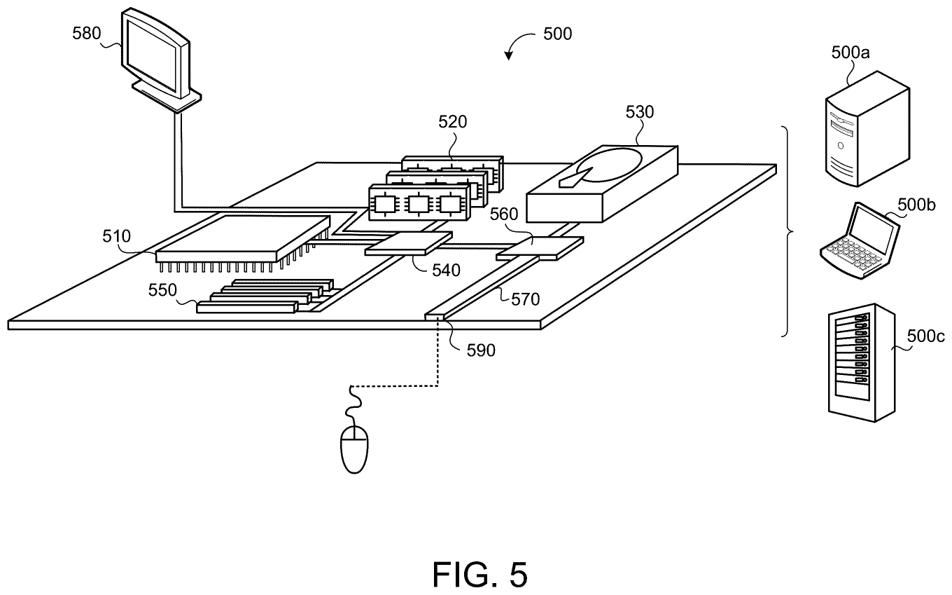

FIG. 4 is a flowchart of an exemplary arrangement of operations for a method 400 of augmenting handling of logs generated in PaaS environments. The method 400 may be performed, for example, by various elements of the system 100 of FIG. 1 or computing device 500 of FIG. 5. For instance, the method 400 may execute on the data processing hardware 144 of the cloud computing environment 140, the data processing hardware 16 of the client device 110, the data processing hardware 510 of computing device 500, or any combination thereof. At operation 402, the method 400 includes transmitting, to an external cloud computing environment 170, an application programming interface (API) request 250. The API request 250 includes a trace identification (ID) 252 including a unique reference object for a first entry 154 in a first log 152 corresponding to the API request 250. The API request also includes a concealment indicator 254 including a Boolean parameter indicating that data corresponding to the API request 250 is confidential. The API request includes a policy identification (ID) 256 indicating a storage criteria for the first entry 154 in the first log 152 corresponding to the API request 250. At operation 404, the method 400 includes updating the first entry 154 in the first log 152 corresponding to the API request 250 based on the trace ID 252 and the concealment indicator 254. At operation 406, the method 400 includes storing the first entry 154 in the first log 152 corresponding to the API request 250 based on the storage criteria of the policy ID 256.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
transmitting, to an external cloud computing environment, an application programming interface (API) request comprising:
a trace identification (ID) comprising a unique reference object for a first entry in a first log corresponding to the API request;
a concealment indicator comprising a Boolean parameter indicating that data corresponding to the API request is confidential; and
a policy ID indicating a storage criteria for the first entry in the first log corresponding to the API request;
updating the first entry in the first log corresponding to the API request based on:
the trace ID; and
the concealment indicator; and
storing the first entry in the first log corresponding to the API request based on the storage criteria of the policy ID.

2. The method of claim 1, wherein the API request is configured to cause the external cloud computing environment to update a second entry in a second log corresponding to the API request, the second entry in the second log comprising the trace ID.

3. The method of claim 2, wherein a first logic of the Boolean parameter of the concealment indicator causes the external cloud computing environment to remove one or more sensitive data fields of data of the API request from the second entry of the second log.

4. The method of claim 3, wherein the operations further comprise:
receiving, from the external cloud computing environment, the second log;
retrieving, from the second log, the trace ID from the second entry corresponding to the API request; and
retrieving, from a database, using the trace ID, the one or more sensitive data fields removed from the second entry of the second log.

5. The method of claim 1, wherein storing the first entry in the first log comprises storing the first entry in the first log for a threshold length of time based on the storage criteria of the policy ID.

6. The method of claim 1, wherein the operations further comprise:
receiving, from the external cloud computing environment, a response to the API request; and
updating a third entry in the first log corresponding to the API request based on:
the response;
the trace ID; and
the concealment indicator.

7. The method of claim 1, wherein the trace ID comprises a hash key.

8. The method of claim 1, wherein the trace ID is included within a body of the API request.

9. The method of claim 1, wherein the trace ID is included as a path parameter of the API request.

10. The method of claim 1, wherein the first log comprises the trace ID.

11. A system comprising:
data processing hardware; and
memory hardware in communication with the data processing hardware, the memory hardware storing instructions that when executed on the data processing hardware cause the data processing hardware to perform operations comprising:
transmitting, to an external cloud computing environment, an application programming interface (API) request comprising:
a trace identification (ID) comprising a unique reference object for a first entry in a first log corresponding to the API request;
a concealment indicator comprising a Boolean parameter indicating that data of the API request is confidential; and
a policy ID indicating a storage criteria for the first entry in the first log corresponding to the API request;
updating the first entry in the first log corresponding to the API request based on:
the trace ID; and
the concealment indicator; and
storing the first log corresponding to the API request based on the storage criteria of the policy ID.

12. The system of claim 11, wherein the API request is configured to cause the external cloud computing environment to update a second entry in a second log corresponding to the API request, the second entry in the second log comprising the trace ID.

13. The system of claim 12, wherein a first logic of the Boolean parameter of the concealment indicator causes the external cloud computing environment to remove one or more sensitive data fields of data of the API request from the second entry of the second log.

14. The system of claim 13, wherein the operations further comprise:
receiving, from the external cloud computing environment, the second log;
retrieving, from the second log, the trace ID from the second entry corresponding to the API request; and
retrieving, from a database, using the trace ID, the one or more sensitive data fields removed from the second entry of the second log.

15. The system of claim 11, wherein storing the first entry in the first log comprises storing the first entry in the first log for a threshold length of time based on the storage criteria of the policy ID.

16. The system of claim 11, wherein the operations further comprise:
receiving, from the external cloud computing environment, a response to the API request; and
updating a third entry in the first log corresponding to the API request based on:
the response;
the trace ID; and
the concealment indicator.

17. The system of claim 11, wherein the trace ID comprises a hash key.

18. The system of claim 11, wherein the trace ID is included within a body of the API request.

19. The system of claim 11, wherein the trace ID is included as a path parameter of the API request.

20. The system of claim 11, wherein the first log comprises the trace ID.
